(19) United States
(12) Patent Application Publication
(10) Pub. No.: US 2009/0077931 A1
(43) Pub. Date: Mar. 26, 2009

(54) METHOD OF INDICATING DIVERGENT PRODUCT BENEFITS

(76) Inventors: Jacqueline Westfield, Walton, KY (US); Jeremy Michael Carter, Union, KY (US)

Correspondence Address: THE PROCTER & GAMBLE COMPANY;Global Legal Department - IP, Sycamore Building - 4th Floor, 299 East Sixth Street, CINCINNATI, OH, 45202, US

(21) Appl. No.: 12/211,140

(22) Filed: Sep. 16, 2008

Related U.S. Application Data
(60) Provisional application No. 60/994,535, filed on Sep. 20, 2007.

(51) Int. Cl. B65B 1/04; C11D 7/00

(52) U.S. Cl. 53/473; 510/235

(57) ABSTRACT

A method of indicating divergent product benefits by formulating a hand dishwashing liquid having a cleaning agent and a hand care agent; choosing a sensory element profile comprising one or more soft colors and a pearlescent appearance; and incorporating the sensory element profile into the hand dishwashing liquid, such that the sensory element profile indicates the efficacy of the cleaning agent and the efficacy of the hand care agent.

### CROSS REFERENCE TO RELATED APPLICATION

This application claims the benefit of U.S. Provisional Application No. 60/994,535, filed Sep. 20, 2007.

### FIELD OF THE INVENTION

The invention relates to methods for indicating divergent product benefits and for communicating cleaning and hand care benefits in a hand dishwashing liquid.

### BACKGROUND OF THE INVENTION

Continuing technological advances in the formulation of cleansing products has allowed for the creation of products which provide contradictory benefits. One example of such a product is a hand dishwashing liquid which provides cleaning benefits and hand care benefits. Such characteristics are generally inconsistent because products which remove grease and dirt from surfaces also tend to remove moisture and oils from the skin. Therefore, a dishwashing liquid which cleans dishes might be expected to make the user's hands dry. Similarly, a dishwashing liquid which moisturizes might be expected not to remove—or even to deposit—undesirable oils on dishes. Consumers are therefore reasonably skeptical when presented with products which claim to serve two or more apparently contradictory purposes at the same time under the same conditions.

The present invention relates to methods for communicating contradictory product benefits to a consumer. More specifically, the present invention relates to sensory elements and specific sensory element profiles which can communicate contradictory product benefits to a consumer, and lessen the discord between the communicated contradictory product benefits. The selection of appropriate sensory element profiles makes it possible to overcome reasonable consumer skepticism about the ability of a single product to satisfy competing or contradictory needs.

### SUMMARY OF THE INVENTION

In some aspects, the present invention provides a method of indicating divergent product benefits, comprising formulating a hand dishwashing liquid comprising a cleaning agent and a hand care agent; choosing a sensory element profile comprising one or more soft colors and a pearlescent appearance; and incorporating the sensory element profile into the hand dishwashing liquid, whereby the sensory element profile indicates the efficacy of the cleaning agent and the efficacy of the hand care agent. In some embodiments, the present invention provides a method of communicating cleaning and hand care benefits in a hand dishwashing liquid comprising formulating a hand dishwashing liquid which generates suds of at least about 70 mm using the Cylinder Test Method; incorporating sensory elements comprising soft color, pearlescence, at least partial opacity, and a viscosity between about 300 cps and about 1100 cps within the hand dishwashing liquid; and packaging the hand dishwashing liquid in a transparent bottle, whereby the sensory elements communicate the efficacy of the cleaning and hand care benefits through the transparent bottle. Additional embodiments and aspects useful in accordance with the present invention are disclosed and claimed.

### DETAILED DESCRIPTION OF THE INVENTION

The present invention was developed through extensive research with consumers. For example, consumers were presented with an array of samples representing different visual sensory elements, and were asked to identify which products appeared to have cleaning benefits, and which products appeared to have hand care benefits. Many consumers associate “hand care benefits” with skin which feels more moisturized after using the product compared to before using the product. “Hand care benefits” may also refer to improved condition or appearance of the skin or nails. “Cleaning benefits” reflects an ability to remove visible particles, starch deposits, and grease deposits from dishes.

Consumers indicate that sensory elements which indicate effective hand care benefits are different than the sensory elements which indicate effective cleaning benefits. This makes it very difficult to present a product which can overcome consumer skepticism about benefit claims directed to contradictory needs. However, specific combinations of product characteristics have been identified which indicate the efficacy of contradictory product benefit claims.

The present invention is therefore a novel contribution to the known use of dyes, perfumes, opacifiers, thickeners, pearlescent agents, and other sensory element additives in that the present invention identifies the unique combinations of sensory elements suitable for communicating divergent product benefits to a consumer, and more specifically, the sensory element profiles suitable for communicating cleaning and hand care benefits in a hand dishwashing liquid. This communication is valuable because inconsistent messages about the product will tend to increase, rather than overcome, consumer skepticism regarding the divergent product benefit claims.

As used herein “dish” means a surface such as dishes, glasses, pots, pans, baking dishes and flatware made from ceramic, china, metal, glass, plastic (polyethylene, polypropylene, polystyrene, etc.) and wood.

As used herein “dishwashing composition” or “dishwashing liquid” refers to those compositions that are employed in manual (i.e. hand) dishwashing. Such compositions are generally high sudsing or foaming in nature.

As used herein “liquid” includes emulsions, microemulsions, suspensions, slurries, etc. in addition to true solutions.

For the purposes of this application, a “dark” or “deep” color means a color which would have a Munsell value of 4 or lower in the Munsell Color System, and a “soft” color means a color which would have a Munsell value greater than 4 in the Munsell Color System. An overview of the Munsell Color System is provided in Webster's Third New International Dictionary (1993) under the entry for “color.”

As used herein “grease” means materials comprising at least in part (i.e., at least 0.5 wt % by weight of the grease) saturated and unsaturated fats and oils, preferably oils and fats derived from animal sources such as beef and/or chicken.

As used herein “starch” means materials comprising at least in part (i.e., at least 0.5 wt % by weight of the starch) amylose or amylopectin.

As used herein “suds profile” means high sudsing and the persistence of sudsing throughout the washing process resulting from the use of the liquid detergent composition of the present invention. This is particularly important as the consumer uses high sudsing as an indicator of the performance of the liquid detergent composition. Moreover, the consumer also uses the sudsing profile as an indicator that the wash solution still contains active detergent ingredients. The consumer usually renews the wash solution when the sudsing subsides. Thus, a low sudsing formulation will tend to be replaced by the consumer more frequently than is necessary because of the low sudsing level.

As used herein “deposits” means grease, starch, oils or particulates that are adhered to a surface, not limited in area or volume of grease, starch, oils or particulates that are adhered to a surface such as dishes, glass, pots, pans, baking dishes, flatware or fabric.

In the context of the present application, a product provides a cleaning benefit if it meets or exceeds the following standards: at least 20% grease soil removal as defined below for the Accelerated Grease Cleaning Test method. Accelerated Grease Cleaning Test results should have a mean value of about 20% to about 100% grease soil removal, preferably the results should have a mean value of about 45% to about 60% grease soil removal. Suds Cylinder Test method result should have a mileage value of about 5 to about 40 additions of soil, preferably about 10 to about 20 additions of soil.

A product provides a hand care benefit if it provides improvement in skin or nail moisturization, appearance, or feel compared to skin condition prior to product use. Improvements in skin appearance and feel can be measured via clinical methodologies commonly used in the beauty care industry. Skin moisturization improvement can be measured using a corneometer, where an increase in capacitance indicates more moisturization and a decrease in capacitance indicates more drying.

### Combinations of Elements

In terms of appearance, the combination of specific sensory elements is important to overall consumer acceptance. When products are rated by consumers for cleaning and hand care based on appearance alone, there is an inverse relationship between the two ratings for most product presentations. The coordination of color, opacity, pearlescence, and other sensory elements is key to achieving a product which will be accepted for both cleaning and hand care.

Combining visual, scent, and tactile elements is not necessarily intuitive and may require consumer feedback. For example, the Waterfalls scent is accepted when associated with an orange color, however, the orange color is not associated with cleaning and hand care, and therefore an orange composition with Waterfalls perfume is not preferred in the present invention.

Generally, an acceptable combination of sensory elements can be drawn from the following options:

| | |
|---|---|
| Color | Soft colors, particularly blue, green, white, |
| | peach, pink, or purple. |
| Pearlescence | Present. |
| Opacity | Partial- the liquid should be neither fully |
| | transparent nor so opaque that any |
| | pearlescent agent is ineffective. |
| Thickness | Between about 300 cps and about 1100 cps |
| | at 20° C. |
| Scent | Stimulating, Natural, Comforting, or |
| | Pampering. |
| Labeling-images | Images, if any, may include representations |
| | of hand care ingredients, hands, dishes, |
| | bubbles, or images associated with the |
| | product scent. |
| Labeling-text | Light colors, preferably gold, silver, white, |
| | yellow, gray, or metallic, selected for |
| | contrast against the label background, or, if |
| | the label is transparent, against the product |
| | color. |
| Labeling-colors | Includes layers of color similar to the |
| | product color. |
| Labeling-textures | Embossed, stamped, foil stamped, |
| | roughened, raised, cut-out, multi-layered or |
| | otherwise textured label. |
| Suds Mileage-Suds Cylinder Test Method | Addition of 0.5 ml grease soil with at least |
| | about 5 soil additions |
| Suds Mileage - Accelerated Grease | Addition of 4.0 ml beef fat with at least |
| Cleaning Test | about 20% soil removal |
| Suds Production-Suds Volume Cylinder | At least about 70 mm suds volume |
| Test Method | |

Suds Production and Suds Mileage are different from the other characteristics listed in that they cannot be assessed prior to purchasing the product. However, these characteristics are widely used by consumers to assess the cleaning effectiveness of a product, and are therefore important to communicating cleaning benefits to a consumer during use, so as to inform consumer decisions about repeat purchases. Suds Mileage is not necessarily associated with hand care benefits. They are important to the communication of the benefits, but are not necessarily inherent in any product having such benefits.

For communication purposes, a hand dishwashing liquid should initially produce suds measuring, in the Suds Volume Cylinder test method described below, at least about 70 mm. More preferably, the hand dishwashing liquid should initially produce suds measuring at least about 80 mm to about 200 mm.

### Color

Consumers indicate that, generally speaking, dark or deep colors are inconsistent with hand care benefits, whereas dark or deep colors are consistent with cleaning benefits. For example, dark green and dark red colors may be consistent with cleaning benefits, but soft pink or soft green colors are more suitable for communicating a hand care benefit. For products which provide both cleaning and hand care benefits, soft colors are also preferred.

For example, when asked if the samples presented appeared to be “hydrating,” approximately twice as many panelists responded positively to a soft green composition compared to a deep green composition. In response to the same question, more than twice as many panelists responded positively to a soft blue composition than to deep or bright blue compositions. Similarly, softer colors were less likely to be identified by respondents with categories such as would “not improve hands,” or “drying.”

As to cleaning benefits, brightly colored transparent samples were top ranked by the consumer panelists for “superior cleaning.” However, soft green and soft blue compositions both scored well for “superior cleaning,” with high marks from over 60% of the panelists. Overall, the soft colors scored well for both cleaning and hand care benefits, where brighter colors scored very well for cleaning and poorly for hand care.

The results were consistent with different color hues, where a soft peach color was ranked favorably compared to a brighter orange-peach color, both of which compared favorably to a bright red color, which was not only ranked low for “hydrating,” but was also identified as “drying.”

In general, the color hues consistent with both cleaning and hand care are pink, peach, green, purple, blue, and white or light beige. These colors may arise in the color hues of the ISCC-NBS system which are described as follows: red (R); reddish orange (rO); orange (O); orange yellow (OY); greenish yellow (gY); yellow green (YG); yellowish green (YG); green (G); bluish green (bG); greenish blue (gB); blue (B); purplish blue (pB); violet (V); purple (P); reddish purple (rP); purplish red (pR); purplish pink (pPk); pink (Pk); yellowish pink (yPk); brownish pink (brPk); brownish orange (brO); or reddish brown (rBr). The ISCC-NBS color hues are described in Webster's Third New International Dictionary under the entry for “color,” and also in the ISCC-NBS Method of Designating Colors and a Dictionary of Color Names (NBC Circular 553, National Bureau of Standards, Washington, 1955).

### Pearlescence

Pearlescent compositions have been well accepted in moisturizing hand soaps and lotions, and it was expected that consumers would associate pearlescence with poor cleaning or with undesirable deposits on dishes. To the contrary, consumers consider pearlescence or shimmer a strong signal of hand care that is also consistent with cleaning benefits.

Pearlescent agents are known in the literature, but generally for use in shampoo, conditioner or personal cleansing applications. They are described as materials which impart to a composition the appearance of mother of pearl.

Organic Pearlescent Agents:

Suitable pearlescent agents include monoester and/or diester of alkylene glycols having the formula:

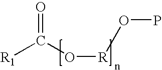

wherein R₁ is linear or branched C₁₂-C₂₂ alkyl group;
R is linear or branched C₂-C₄ alkylene group;
P is selected from H, C₁-C₄ alkyl or —COR₂, R₂ is C₄-C₂₂ alkyl, preferably C₁₂-C₂₂ alkyl; and
n=1-3.
   In one embodiment of the present invention, the long chain fatty ester has the general structure described above, wherein R₁ is linear or branched C₁₆-C₂₂ alkyl group, R is —CH₂—CH₂—, and P is selected from H, or —COR₂, wherein R₂ is C₄-C₂₂ alkyl, preferably C₁₂-C₂₂ alkyl.

Typical examples are monoesters and/or diesters of ethylene glycol, propylene glycol, diethylene glycol, dipropylene glycol, triethylene glycol or tetraethylene glycol with fatty acids containing from about 6 to about 22, preferably from about 12 to about 18 carbon atoms, such as caproic acid, caprylic acid, 2-ethyhexanoic acid, capric acid, lauric acid, isotridecanoic acid, myristic acid, palmitic acid, palmitoleic acid, stearic acid, isostearic acid, oleic acid, elaidic acid, petroselic acid, linoleic acid, linolenic acid, arachic acid, gadoleic acid, behenic acid, erucic acid, and mixtures thereof.

In one embodiment, ethylene glycol monostearate (EGMS) and/or ethylene glycol distearate (EGDS) and/or polyethylene glycol monostearate (PGMS) and/or polyethyleneglycol distearate (PGDS) are the pearlescent agents used in the composition. There are several commercial sources for these materials. For example, PEG6000MS® is available from STEPAN; EMPILAN EGDS/A® is available from ALBRIGHT & WILSON.

In another embodiment, the pearlescent agent comprises a mixture of ethylene glycol diester/ethylene glycol monoester having the weight ratio of about 1:2 to about 2:1. In another embodiment, the pearlescent agent comprising a mixture of EGDS/EGMS having the weight ratio of about 60:40 to about 50:50 is found to be particularly stable in water suspension.

Inorganic pearlescent agents include those selected from the group consisting of mica, metal oxide coated mica, silica coated mica, bismuth oxychloride coated mica, bismuth oxychloride, myristyl myristate, glass, metal oxide coated glass, guanine, glitter (polyester or metallic) and mixtures thereof.

Suitable micas includes muscovite or potassium aluminum hydroxide fluoride. The platelets of mica are preferably coated with a layer of metal oxide. Preferred metal oxides are selected from the group consisting of rutile, titanium dioxide, ferric oxide, tin oxide, alumina and mixtures thereof. The crystalline pearlescent layer is formed by calcining mica coated with a metal oxide at about 732° C. The heat creates an inert pigment that is insoluble in resins, has a stable color, and withstands the thermal stress of subsequent processing.

Color in these pearlescent agents develops through interference between light rays reflecting at specular angles from the top and bottom surfaces of the metal-oxide layer. The agents lose color intensity as viewing angle shifts to non-specular angles and gives it the pearlescent appearance.

More preferably inorganic pearlescent agents are selected from the group consisting of mica and bismuth oxychloride and mixtures thereof. Most preferably inorganic pearlescent agents are mica. Commercially available suitable inorganic pearlescent agents are available from Merck under the tradenames IRIODIN, BIRON, XIRONA, TIMIRON, COLORONA, DICHRONA, CANDURIN and RONASTAR. Other commercially available inorganic pearlescent agent are available from BASF (ENGELHARD, MEARL) under tradenames BIJU, BI-LITE, CHROMA-LITE, PEARL-GLO, MEARLITE and ECKART under the tradenames PRESTIGE SOFT SILVER and PRESTIGE SILK SILVER STAR.

Organic pearlescent agents such as ethylene glycol mono stearate and ethylene glycol distearate provide pearlescence, but only when the composition is in motion. Hence only when the composition is poured will the composition exhibit pearlescence. Inorganic pearlescent materials are preferred as they provide both dynamic and static pearlescence. By dynamic pearlescence it is meant that the composition exhibits a pearlescent effect when the composition is in motion. By static pearlescence it is meant that the composition exhibits pearlescence when the composition is static.

Inorganic pearlescent agents are available as a powder, or as a slurry of the powder in an appropriate suspending agent. Suitable suspending agents include ethylhexyl hydroxystearate and hydrogenated castor oil. The powder or slurry of the powder can be added to the composition without the need for any additional process steps.

Pearlescent agents may also be added to the packaging materials, such as the bottle or the label. A bottle or label having a pearlescent appearance may increase the effect of the pearlescent agent in the dishwashing composition, emphasize the pearlescence of the dishwashing composition, or reiterate the pearlescence of the dishwashing composition.

### Opacity

The light transmission capability of the composition is also important, as transparent compositions are associated with cleaning, but are not associated with hand care. Similarly, compositions which are opaque may not be perceived as offering an acceptable level of cleaning benefit, although they may be associated with creams or lotions and be perceived as having hand care benefits. Opaque, pearlescent presentations acceptably communicate both cleaning and hand care benefits. The combination of opacity and pearlescence appears to be important in this regard, although an opaque, non-pearlescent composition is still preferred to a translucent or transparent product. The opacity of the composition has an upper bound at the point where the pearlescent agent loses effect due to the low light transmission beneath the surface of the composition. This upper bound will vary dependent on the types and amounts of materials used in the composition.

Opacity may be measured using the LAB scale, as described in HunterLab Insight on Color, Aug. 1-15, 1996, Vol. 8, No. 9 (available at http://www.hunterlab.com/appnotes/an08_{—}96a.pdf). The “L” value in the LAB color scale varies from 0 to 100, where 100 is a perfect reflecting diffuser, and zero is black. For purposes of the present application, a translucent appearance transmits sufficient light to perceive shape or color through the translucent material, where objects beyond the material cannot be seen clearly. A transparent appearance allows the consumer to see completely through the transparent material, and an opaque appearance does not permit the consumer to see through the opaque material. Roughly, on the LAB scale, when the calorimeter is calibrated against distilled water, an opaque material registers below 50; a translucent material registers between 50 and 85; and a transparent material registers 85 or higher. Pearlescent agents may increase the variation between repeat measurements, particularly if the agents are not uniformly suspended in the composition. As a result, it may be desirable to measure the opacity of the solution before adding any static pearlescent agents.

A composition which is not inherently opaque may be opacified using known materials, such as LYTRON (MORTON THIOKOL, INC.), a modified polystyrene latex, or ethylene glycol distearate. Such opacifiers would generally be present at levels of 10 wt. percent or less of the composition.

### Labeling

In some aspects of the present invention, the presentation of the product may include a label. The label is fashioned to emphasize and reiterate the sensory element profile of the dishwashing composition. The label may be embossed to provide an additional sensory element in the form of texture (touch) or shading (visual). The label may present graphics, texturing, color, and/or words which emphasize the pearlescence or shimmer of the composition. For example, on a transparent bottle the label may also be transparent and include regions having two or more shades of the color of the product, such that the label highlights the appearance of the dishwashing composition itself. The transparent label may include layers of color, that is, various colors of the same hue as the dishwashing composition, but having varied lightness or saturation. For example, if the hand dishwashing liquid is light purple in color, the label may include very light purple, brilliant purple, and dark purple. The label may also include the color of the hand dishwashing liquid itself. The label may include, alternatively or in addition, distinctive colors such as gold or silver to stand out against the product appearance. The label may use metallic inks or substrates to further draw out the pearlescence and color of the dishwashing composition. At least some of the indicia on the label may use bright colors, such as white, gold, yellow, or silver, to emphasize the soft color and pearlescence of the dishwashing composition.

The label may also emphasize the inclusion of hand care benefits or the inclusion of cleaning benefits, or both. In some embodiments, the label will incorporate representations of a hand care additive, such as vitamin E, Aloe, or Menthol. The label may include indicia of hands, bubbles, dishes, or images associated with the composition scent. For example, the label may include representations of lavender plants, pomegranate fruits, aloe leaves, or a waterfall to indicate the composition scent. In some embodiments, the representations are stylized to achieve a specific “feel” or experience, rather than providing a literal, true-to-life representation of a plant or other object.

### Thickness

Thickness is another product characteristic which may be useful as a sensory element. Although thickness would typically be a feel or touch element, for the purposes of communication prior to purchase thickness is a visual element. The thickness of the composition may signal superior hand care benefits. Consumers may evaluate the thickness of the composition statically. That is, consumers may look at the bottle on the shelf and determine that the composition appears to be thick and viscous. For the consumer, this may be associated with the opacity, color, or other attributes of the composition. Alternately, thickness may be assessed by picking up and moving the bottle, observing the flow characteristics of the liquid. It has been found that consumers will generally accept a composition having a viscosity of up to about 100 centipoise at 20° C., in combination with the other preferred sensory elements according to the present invention. Viscosity significantly above this range may lead consumers to anticipate problems rinsing the composition off of their dishes.

The at-rest viscosity of the compositions herein will ideally be high enough to accomplish several purposes. Chief among these purposes is that the composition at rest should be sufficiently viscous to suitably suspend a pearlescent agent. A secondary benefit of a relatively high at-rest viscosity is an aesthetic one of giving the composition the appearance of a thick, strong, effective product as opposed to a thin, weak, watery one. The minimum viscosity required to achieve these purposes is about 300 cps at 20° C. Finally, the requisite rheological characteristics of the liquid matrix should be provided via an external rheology modifier which does not disadvantageously detract from the visibility of the aesthetic agent suspended within the composition, i.e., by making the matrix opaque to the extent that the suspended aesthetic agent is obscured.

### Scent

Although cleaning compositions typically are provided in closed bottles, many consumers will open the bottle to smell the product before purchasing it. Fragrance oils used within cleaning compositions often comprise a plurality of different Perfume Raw Materials (PRM). Perfume raw materials include many odiferous chemical compounds. A wide variety of chemicals is known for fragrance uses, including, without limitation, certain aldehydes, ketones, alcohols, terpenes, amines, ethers, hydrocarbons, imines, lactones, thiols and esters. Certain naturally occurring plant and animal oils comprising complex mixtures of various chemical components may also be used as fragrances. The individual PRMs which make up a natural oil may be found by reference to journals commonly used by those skilled in the art such as “Perfume and Flavourist” (ISSN: 1041-2905) or “Journal of Essential Oil Research” (ISSN: 0272-2666). As used herein, the term “perfume” encompasses individual PRMs as well as perfume accords. Perfume accords may be premixed and added to the liquid detergent composition in ensemble, or perfume accords may be achieved in the liquid detergent composition by the addition of individual PRMs. It has been discovered that, in products claiming cleaning and hand care benefits, consumers tend to favor perfumes which can be described as Stimulating, Natural, Comforting, or Pampering.

Many perfumes have notes which fall into more than one of these groups. For example, a given perfume useful in the present invention may be Comforting and Natural, or Stimulating and Pampering. A perfume may also have notes which fall into groups which may or may not be associated with cleaning, moisturizing, or a combination of cleaning and moisturizing, so long as it also contains notes which fall into the favored groups. For example, a perfume may be described as Stimulating, Fun, and Sensual, or Stimulating, Pampering, and Light. Specific examples of perfumes useful in the present invention include Pomegranate & Rose, Lavender & Vanilla, and Waterfalls. Other perfumes useful in the present invention may smell like Aloe, Menthol, or other ingredients associated with hand care or cleaning benefits.

It is typical for the character of a fragrance to be designed to alter and develop over the product use cycle and during the time that the fragrance is deposited on a substrate as the different PRMs evaporate and are detected by the user. For example, PRMs which have a high volatility and low substantivity are commonly used to give an initial impression of characters such as light, fresh, fruity, citrus, green or delicate floral to the fragrance. These characters are detected during or soon after application. Such materials are commonly referred to in the field of fragrances as “top notes,” and generally have a boiling point less than or equal to 250° C. at a pressure of 1 atm. In contrast, the less volatile and more substantive PRMs are typically used to give characters such as musk, sweet, balsamic, spicy, woody or heavy floral to the fragrance oil which, although detectable soon after application, also last for longer. These materials are commonly referred to as “middle notes” or “base notes.”

In the case of a dishwashing liquid, consumers commonly prefer fragrances which are dominated by transient top notes. Consumers generally do not like dishes and other surfaces which come into contact with food to retain any detectable scent after cleaning. The fragrances in the dishwashing liquid are primarily for communicating with the consumer and for the pleasure of the user during use, not for scenting the dishes. In this context, a dishwashing liquid may be said to be dominated by top notes if the compounds contributing to the top notes comprise 50% or more by volume of the total perfumes included in the composition. Examples of volatile top note PRMs having a boiling point of less than or equal to 250° C. include, but are not limited to, anethol, methyl heptine carbonate, ethyl aceto acetate, para cymene, nerol, decyl aldehyde, para cresol, methyl phenyl carbinyl acetate, ionone alpha, ionone beta, undecylenic aldehyde, undecyl aldehyde, 2,6-nonadienal, nonyl aldehyde, octyl aldehyde, phenyl acetaldehyde, anisic aldehyde, benzyl acetone, ethyl-2-methyl butyrate, damascenone, damascone alpha, damascone beta, flor acetate, frutene, fructone, herbavert, iso cyclo citral, methyl isobutenyl tetrahydro pyran, iso propyl quinoline, 2,6-nonadien-1-ol, 2-methoxy-3-(2-methylpropyl)-pyrazine, methyl octine carbonate, tridecene-2-nitrile, allyl amyl glycolate, cyclogalbanate, cyclal C, melonal, gamma nonalactone, cis 1,3-oxathiane-2-methyl-4-propyl, benzaldehyde, benzyl acetate, camphor, carvone, borneol, bornyl acetate, decyl alcohol, eucalyptol, linalool, hexyl acetate, iso-amyl acetate, thymol, carvacrol, limonene, menthol, iso-amyl alcohol, phenyl ethyl alcohol, alpha pinene, alpha terpineol, citronellol, alpha thujone, benzyl alcohol, beta gamma hexenol, dimethyl benzyl carbinol, phenyl ethyl dimethyl carbinol, adoxal, allyl cyclohexane propionate, beta pinene, citral, citronellyl acetate, citronellal nitrile, dihydro myrcenol, geraniol, geranyl acetate, geranyl nitrile, hydroquinone dimethyl ether, hydroxycitronellal, linalyl acetate, phenyl acetaldehyde dimethyl acetal, phenyl propyl alcohol, prenyl acetate, triplal, tetrahydrolinalool, verdox, and cis-3-hexenyl acetate.

### Cleaning and Hand Care Benefits

A variety of means for formulating a dishwashing liquid with cleaning and hand care benefits are known in the art. Traditionally, hand care benefits have been expressed as mildness or low irritancy, due to technical challenges in balancing cleaning and hand care benefits. More recently, technical approaches have been developed to improve both the cleaning and hand care benefits of such combination products.

Known approaches are described, for example, in European Patent EP 0 487 169 B 1 to Jakubicki et al. (Concentrated liquid detergent composition containing alkyl benzene sulfonate and magnesium); European Patent EP 0 510 870 B1 to Saijo et al. (Milky detergent composition for hard surfaces); European Patent EP 0 550 652 B1 to Fu et al. (Detergent compositions containing alkyl ethoxy carbozylates and polyhydroxy fatty acid amines); European Patent EP 0 658 186 B1 to Ofosu-Asante (Liquid or gel dishwashing detergent containing a polyhydroxy fatty acid amide, calcium ions and an alkylpolyethoxypolycarboxylate); European Patent EP 0 719 321 B1 to Mao et al. (Light duty liquid or gel dishwashing detergent compositions containing protease); and European Patent EP 0824 580 B1 to Cottrell et al. (Light duty cleaning composition).

Formulations may include specific skin care ingredients which serve as moisturizers, skin protectants, emollients, humectants, or otherwise provide skin care benefits. Examples of such compounds are disclosed, for example, in European Patent Application EP 0 770 593 A1 by Okutsu (Tris(3-aminopropyl)amine derivative and detergent composition containing the same); European Patent Application EP 1 454 620 A2 by Fujimura (Skin aging-preventing or improving agent); European Patent Application EP 0 651 049 A2 by Graubart et al. (Antimicrobial dish washing liquid); and PCT Patent Application WO 2007/007255A2 by Xie et al. (Personal care compositions and methods for the beautification of mammalian skin and hair).

Some consumers prefer hand care ingredients which are natural skin care ingredients. Such natural skin care ingredients include botantical extracts from plants such as aloe vera, lavender and oatmeal, and are generally differentiated from synthetic chemicals designed to induce similar effects. Other natural skin care ingredients or sources for natural skin care ingredients include shea butter, vitamin E, chamomile, tea tree oil, almonds, coconuts, ocean or sea salts, avocado, olive oil, hibiscus, cucumber, sweet almond, grapeseed, macadamia, mango, jojoba, cocoa, rice bran, neem, eucalyptus, goat's milk, anise, apricot, bergamot, calendula, comfrey root, coriander, eggs, elderflower, green tea, licorice, cow's milk, papaya, red clover, rose, witch hazel, and yogurt.

One of ordinary skill in the art will appreciate that there are a multitude of other approaches to providing a liquid detergent which provides cleaning and skin care benefits, and that the present invention is not limited to the methods or materials described in the references noted above.

### Other Signal Ingredients

Other signal ingredients may be used to reinforce the communication of divergent benefits after the consumer has purchased the product, when the product is employed for its intended purpose. For example, a cleaning product may include menthol, menthol-related compounds, or eucalyptus, which impart distinctive odors associated with cleanliness. In the case of a dishwashing liquid or other cleaning product which comes in contact with the user's skin, menthol has the added effect of creating a cooling sensation on the skin, which users may associate with skin care benefits. Users may also enjoy the cooling sensation without associating the sensation with any other benefit. “Contact sensates” like menthol include menthol derivatives, which may have stronger effects, weaker effects, longer-lasting effects, lower irritancy, or other effects preferable to menthol. Useful menthol derivatives are described in U.S. Pat. No. 6,277,385 to Luke, among other references. Contact sensates also include warming sensates such as capsicum, red pepper powder, capsaicin, homo-capsaicin, homo-dihidrocapsaicin, nonanoyl vanillyl amide, nonanoic acid vanillyl ether, vanillyl alcohol alkyl ether derivatives, isovanillyl alcohol alkyl ether derivatives, ethylvanillyl alcohol alkyl ether derivatives, substituted benzyl alcohol alkyl ether derivatives, vanillin propylene glycol acetal, ethylvanillin propylene glycol acetal, ginger extract, gingerol, 4-(1-menthoxymethyl)-2-(3′-methoxy-4′hydrophenyl)-1,3-dioxolane and analogs, and gingerone. A given formula may include sensates which induce warm sensations, cool sensations, tingling sensations or other sensations, or some combination of sensates to induce multiple or complex sensations.

Other additives which may reinforce the communication of divergent benefits are additives which complement or increase the effect of the primary hand care ingredients, or which impart additional hand care benefits. Such additives include depigmentation agents, reflectants, film forming polymers, humectants, amino acids and their derivatives, antimicrobial agents, allergy inhibitors, anti-acne agents, anti-aging agents, anti-wrinkling agents, antiseptics, analgesics, local anesthetics, hair growth inhibitor agents, antihistamines, antiinfectives, inflammation inhibitors, vasoconstrictors, vasodilators, wound healing promoters, peptides, polypeptides, proteins, deodorants, anti-perspirants, medicament agents, skin emollients, skin moisturizers, skin firming agents, vitamins, tanning agents, skin lightening agents, antifungals, depilating agents, counterirritants, burn products, prickly heat agents, make-up preparations, herbal extracts, retinoids, anti-oxidants, hair lighteners, chelating agents, coloring agents, pigments, sunscreens, anti-edema agents, collagen enhancers, and mixtures thereof.

Additives may include beads, ribbons, pearls, films, gels, or other suspended or suspendable (as by shaking or mixing) particles. Such particles may comprise additives which confer cleaning, hand care, or other benefits, or they may be purely aesthetic.

### Test Methods and Measurements

### Viscosity Test Method

The viscosity of the composition of the present invention is measured on a Brookfield viscometer model # LVDVII+ at 20° C. The spindle used for these measurements is S31 with the appropriate speed to measure products of different viscosities; e.g., 12 rpm to measure products of viscosity greater than 1000 cps; 30 rpm to measure products with viscosities between 500 cps-1000 cps; 60 rpm to measure products with viscosities less than 500 cps.

### Dynamic Dissolution Test (DDT)

The DDT allows the user to determine the dissolution profile, in percentage, over time for a given detergent composition sample using conductivity monitoring, under fixed test conditions.

Set an overhead stirrer (ex. RW20DZM.n from IKA labortechnik) at 90 RPM (±1) so that the stirrer may be placed inside of a 5000 mL glass beaker. Place a steel 400 g cylindrical weight (diameter 50 mm height 28 mm) in the bottom centre of the beaker. Fill the beaker up to the 4 liters mark with 20° C. demineralised water. Place the beaker under the overhead stirrer, plunge the four blade mixer into the water to a depth of 5 cm, making sure that the stirrer is right in the middle of the beaker (aligned with cylindrical weight). Place the conductivity probe (ex. Conductimeter LF340A/set from WTW) into the water to a depth of 4 cm (the probe must be entirely in the water) and close to the beaker wall (approx 1 cm between probe and wall). Measure the conductivity of the water: this must be below 5 μS/cm.

Add a 5 mL sample of the sample to be tested gently on the bottom of the beaker half way between cylindrical piece and beaker wall. Repeated testing should use the same location for each round of testing. Start the overhead stirrer and conductimeter simultaneously immediately after introduction of the sample. Set the conductimeter to take measurements at intervals of 5 seconds. End the test when the conductivity reading is steady for 20 seconds.

Subtract the initial conductivity value (for demineralised water) from each data point of the test, such that initial conductivity is set a zero. Set the end point conductivity value at 100%, then calculate the percentage dissolution for each data point from the set knowing end-point conductivity value is 100%. Record the time taken to reach 70% and 90% dissolution of the composition.

### Suds Mileage Test

### Accelerated Grease Cleaning Test

Prepare one gallon of 41.7° C. (107° F.) water in a falling water reservoir adjusted to 7 gpg hardness so that the water falls by gravity into a dishpan for a distance of at least 61 cm (24 inches) but less than 122 cm (48 inches). Position a 3.79 L (1 gallon) dishpan so that the stream of falling water will hit in the center of the dishpan. Dispense enough product sample to make a 0.09% concentration in 3.79 L into the steam of water after 5 sec. after turning on the pump to activate the falling water. Deliver 4.0 ml of soil onto a 10″ diameter MELMAC dinner plate. Spread the soil evenly over the entire face of the plate with a cotton dishcloth. Immerse plate into the dishwater at a 15° angle from vertical (i.e., the plate front 195° from the water surface) with the bottom edge of the plate resting upon the pan bottom, halfway between the center and left edge of the pan.

With the dishcloth in the fingers of the hand, start washing. The washing motion consists of one complete circular motion of the cloth from the bottom of the pan out of the water around the face and back to the original position at the bottom of the pan. The cloth should contact the plate over a palm-sized area. When passing over the plate, use a very light pressure, sufficient, however, to squeeze some dishwater from the cloth down over the plate.

Make ten uniformly timed washing motions in six seconds. After the tenth stroke, squeeze the excess water from the cloth over the back of the plate held over the center of the pan, and repeat the procedure from the addition of the soil. This constitutes the washing of one plate—six seconds to wash the plate, and six seconds to squeeze the cloth, and the soil, and spread the soil. A mechanical counter is used to register the number of plates washed. Continue this soiling/washing procedure until a suds endpoint is reached. The “suds endpoint” is defined as a break in the layer of suds about 3″ in diameter that remains for 3 to 5 seconds.

Record Data: The suds mileage is recorded as the number of soil additions made.

### Suds Cylinder Test Method

Set a rotating cylinder system similar as that shown and described in U.S. Pat. No. 6,849,751 having eight 500 mL cylinders to rotate at 20-21 RPMs. The speed and time can be adjusted. Preset the machine to rotate for one minute at 20-21 RPMs. Adjust water to 7 gpg. Adjust water to pH of 7.4. (±0.1 pH units). Measure out 500 mL of water into each cylinder. With a permanent marker, carefully draw a line across the top height of the water. Preheat the 500 mL graduated cylinder with water in a 65° C. water bath. Once water is at 65° C., place cylinders in instrument without lids. Once temperature drops in cylinders to 55° C., dispense 0.5 mL of a sample into each cylinder.

Stir each sample solution without touching the bottom of the cylinder with a stirring rod until all the sample has dissolved. Monitor the temperature of the wash solution in each cylinder. When the temp is 7.78° C. (46° F.), cap the cylinder, place rubber stopper in the cap, and attach the cylinders to the rotational cylinder system. When all of the cylinders are ready, rotate the cylinders twice and release the pressure from each one by removing the stoppers. Replace the stoppers and rotate the cylinders for two minutes.

As quickly as possible remove stoppers, with permanent marker, draw a line at the top height of the suds. Measure the difference between the two marks to the nearest millimeter for the suds volume. Run up to four repetitions. Rotate the product position in each repetition. For example: R1: 1-2-3-4-5-6-7-8; R2: 8-7-6-5-4-3-2-1. Also change the position of the control from test to test. If the suds are not straight across, or the top layer of suds has large airy bubbles, take the reading at a point of average between the very top and where the foam becomes level or more dense.

### LAB Opacity Measurement Method

Using an Ultrascan XE Hunter LAB Colorimeter, calibrate the system according to the manufacturer's instructions using distilled water. Set the illuminant value to D₆₅. Set the M1 Illuminant value to D₆₅. Select RSIN mode with Nominal UV filter, and select DEcmc value recording. Clean and dry the sample cuvette thoroughly between samples.

### EXAMPLE 1

A liquid dishwashing composition is formulated to provide cleaning and hand care benefits, using any available technologies. The dishwashing composition is formulated using dyes, perfumes, pearlizers, and other additives to achieve the following combination of sensory elements:

| | |
|---|---|
| Color | Soft Purple |
| Pearlescence | Present. |
| Opacity | Partial. |
| Thickness | Approximately 1050 cps. |
| Scent | Comforting, Lavender & Vanilla |
| Labeling-images | Stylized image of lavender blossoms. |
| Labeling-text | Capital letters in varied gold ink, to create |
| | the impression of shine or reflection, even |
| | when the bottle is stationary. |
| Labeling-colors | The label is transparent, and includes at |
| | least 3 shades of soft purple, each slightly |
| | different than the soft purple color of the |
| | product. |
| Labeling-textures | The images of lavender blossoms are |
| | embossed in the label. |

### EXAMPLE 2

A liquid dishwashing composition is formulated to provide cleaning and hand care benefits, using any available technologies. The dishwashing composition is formulated using dyes, perfumes, pearlizers, and other additives to achieve the following combination of sensory elements:

| | |
|---|---|
| Color | Soft Green |
| Pearlescence | Present. |
| Opacity | Partial. |
| Thickness | Up to 1050 cps. |
| Scent | Stimulating & Pampering, |
| | Waterfalls. |
| Labeling-images | Images of bubbles and hands. |
| Labeling-text | Lowercase letters in white. |
| Labeling-colors | The label is transparent, and |
| | includes at least 3 shades of soft |
| | green, each slightly different than |
| | the soft green color of the |
| | product. |
| Labeling-textures | The images of bubbles are |
| | embossed along the edges of the |
| | label. |

### EXAMPLE 3

A liquid dishwashing composition is formulated to provide cleaning and hand care benefits, using any available techonologies. The dishwashing composition is formulated using dyes, perfumes, pearlizers, and other additives to achieve the following combination of sensory elements:

| | |
|---|---|
| Scent | Pomegranate & Rose |
| Color | Soft Pink. |
| Pearlescence | Present. |
| Opacity | Partial. |
| Thickness | Approximately 1050 cps. |
| Scent | Stimulating, Pomegranate & Rose |
| Labeling-images | Highly stylized image of whole |
| | pomegranate fruits on what |
| | appears to be a vine. |
| Labeling-text | Capital letters in varied gold ink, |
| | to create the impression of shine |
| | or reflection, even when the |
| | bottle is stationary. |
| Labeling-colors | The label is transparent, and |
| | includes at least 3 shades of soft |
| | pink, each slightly different than |
| | the soft pink color of the product. |
| Labeling-textures | The images of pomegranates are |
| | embossed in the label. |

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm”.

All documents cited in the Detailed Description of the Invention are, in relevant part, incorporated herein by reference; the citation of any document is not to be construed as an admission that it is prior art with respect to the present invention. To the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A method of communicating cleaning and hand care benefits in a hand dishwashing liquid comprising:
formulating a hand dishwashing liquid which generates suds of at least about 70 mm using the Cylinder Test Method;
incorporating sensory elements comprising soft color, pearlescence, at least partial opacity, and a viscosity between about 300 cps and about 1100 cps within the hand dishwashing liquid; and
packaging the hand dishwashing liquid in a transparent bottle,
whereby the sensory elements communicate the efficacy of the cleaning and hand care benefits through the transparent bottle.

2. The method of claim 1, wherein the transparent bottle is labeled with a transparent label.

3. The method of claim 2, wherein the transparent label has a surface, at least part of the surface being textured.

4. The method of claim 2, wherein the transparent label includes printed indicia, said printed indicia having metallic, gold, silver, white, or yellow appearance, whereby the printed indicia on the transparent label highlight the soft color and the pearlescence in the hand dishwashing liquid.

5. The method of claim 1, wherein the soft color is of a hue selected from R, rO, O, OY, gY, YG, yG, G, bG, gB, B, pB, V, P, rP, pR, pPk, Pk, yPk, brPk, brO, and rbR.

6. The method of claim 5, wherein the transparent bottle is labeled with a transparent label, and the transparent label comprises layers of color in the same hue as the hand dishwashing liquid.

7. The method of claim 1, wherein the hand dishwashing liquid results at least 20% grease soil removal by the Accelerated Grease Cleaning Test method.

8. The method of claim 1, wherein the transparent bottle is pearlescent.

9 The method of claim 1, wherein the hand dishwashing liquid comprises a fragrance dominated by top notes.

10. The method of claim 1, wherein the hand dishwashing liquid comprises contact sensates.

11. A method of indicating divergent product benefits, comprising:
formulating a hand dishwashing liquid comprising a cleaning agent and a hand care agent; choosing a sensory element profile comprising:
one or more soft colors; and
a pearlescent appearance; and
incorporating the sensory element profile into the hand dishwashing liquid, whereby the sensory element profile indicates the efficacy of the cleaning agent and the efficacy of the hand care agent.

12. The method of claim 12, wherein the sensory element profile further comprises a fragrance dominated by top notes.

13. The method of claim 12, wherein the hand care agent is a natural skin care ingredient.
